(19) United States
(12) Patent Application Publication
(10) Pub. No.: US 2011/0302023 A1
(43) Pub. Date: Dec. 8, 2011

(54) METHOD FOR ISSUING AND REDEEMING AN ELECTRONIC COUPON

(76) Inventors: Christoph Thye, Dortmund (DE); Constantin Rack, Hagen (DE)

(21) Appl. No.: 13/118,981

(22) Filed: May 31, 2011

(30) Foreign Application Priority Data
Jun. 4, 2010 (DE) 10 2010 029 718.6

(51) Int. Cl. G06Q 30/00

(52) U.S. Cl. 705/14.36

(57) ABSTRACT

A method for issuing and redeeming an electronic coupon is provided. An electronic coupon is created by a central server, the coupon including information about a discount or a credit, and one or more conditions. The coupon is assigned to a customer identifier. A coupon query is transferred, which includes the customer identifier, from a point-of-sale computer to the central server. Coupon data is transferred from the central server to the point-of-sale computer. The described method reduces the transaction time for redeeming and issuing personalized coupons. In particular, the coupon data for multiple coupons is transferred with an assigned coupon identifier before the payment process from the central server to the point-of-sale computer, and stored in a local memory. In the payment process, the central computer transfers the coupon identifiers assigned to the customer identifier. The point-of-sale computer retrieves the coupon data from the local memory, using the coupon identifier.

### TECHNICAL FIELD

The invention relates to a method for issuing and redeeming an electronic coupon, with the following steps:
Creation of an electronic coupon by a central server, the coupon at least containing information about a discount granted or a credit, as well as one or more conditions;
Assignment of the coupon to a customer identifier;
Transfer of a coupon query, which contains at least a customer identifier, from a point-of-sale computer via a data network to the central server,
Transfer of the coupon data from the central server via a data network to the point-of-sale computer.

### BACKGROUND

Systems are already known for issuing and redeeming coupons, these systems comprising a point-of-sale computer, for example a local cash register system, and a central server, and the customer identifying himself/herself by one or more identification characteristics (e.g. by a password or a PIN), the cash register system sending this customer identifier, subsequently referred to more briefly as a customer ID, to the central server, and the server returning to the cash register system the data of one or more coupons in response.

Such systems are known, for example, in the printed publications WO 02/071179 A2 and EP 1 968 004 A1. WO 02/071179 A2 and EP 1 968 004 A1 are incorporated herein by reference.

The redemption and issuing of coupons should be processed very rapidly, in order not to interfere with the payment process. A method of this kind would be rendered unattractive by queues at the till caused by long transaction times for coupon redemption and issuing.

With the growing acceptance of mobile couponing, there is also a rise in the number of personalized coupons, which are stored for a particular customer on a central server and are available for redemption.

In contrast to simple discounts, the coupon data includes several components, for example the EAN/GTIN (European Article Number/Global Trade Item Number), the discount value, the coupon layout including images for imprint, and the conditions for redemption/issuing of the coupon. If this data is not transferred until during the payment process, it leads to a high data volume and can take considerable time. This delays the payment process, especially as the transferred data then has to be read in and evaluated.

It is the object of the present invention to reduce the transaction time for redeeming and issuing personalized coupons.

This object is achieved according to the invention in that
the complete coupon data for multiple coupons is transferred with an assigned coupon identifier before the payment process from the central server to the point-of-sale computer, and stored by this in a local memory,
in the payment process the central computer transfers the coupon identifiers assigned to the customer identifier and
the point-of-sale computer retrieves the complete coupon data from the local memory, using the coupon identifier.

In other words, the invention comprises so-called coupon caching. In this, the coupon data is transferred to the point-of-sale computer (cash register system) at times when there is little or no customer traffic, and there it is stored in conjunction with unique coupon identifiers (also called coupon IDs) which are assigned to the respective coupon. The cash register system sends the customer's identification characteristic (customer ID) to the central server, and receives in response only the coupon IDs which are assigned to the customer. The data volume of the coupon IDs is much less than the data volume for the coupon data. The coupon data itself is then retrieved from the local copy using the coupon IDs, and is immediately available for subsequent processing.

The coupon data is preferably transferred during the times when the points of sale are closed, and the point-of-sale computers or cash register systems are not needed for sales. But it is also possible to operate a communication computer in the various shops (points of sales) during their opening hours, this computer retrieving the coupon data independently of the billing transaction and storing it in a local memory. The communication computer is not used for handling payment processes and is linked via a local data network (LAN) to the cash register system. The cash register system therefore does not have to retrieve the coupon data via a wide area network (WAN) such as the Internet: it can retrieve it via the LAN from the communication computer. With customary data transfer rates of 1 to 6 MBit/s for WANs and 100 to 1000 MBit/s for LANs, this results in a considerable acceleration.

A further acceleration results if the coupon data is stored locally on a hard disk in the cash register system itself. Data on modern hard disks is transferred via data buses according to the SATA standard data at well over 1000 MBit/s to the cash register system processor.

In practice, after the customer identifier is transferred the central computer can carry out a validation of the coupons assigned to the customer identifier, and only transfer to the point-of-sale computer the coupon identifiers which are assigned to valid coupons. This step means that the validity check for the individual coupons is performed by the central server rather than the point-of-sale computers.

The central server consequently performs an advance check (coupon preselection) of all coupons assigned to the customer, and transmits only those coupon IDs which can possibly be valid based on their input or issuing conditions. Coupon IDs of coupons which were used shortly beforehand by the customer, and are therefore no longer available, are not transmitted. Validity checking of coupons by the central server reduces the quantity of data transferred, because the IDs of invalid coupons are not transferred. Furthermore, the validity check is performed by the central server, which is not taxed with performing the payment process. The central server can be a powerful machine with a fast processor, which can perform the checking very much faster than the processor of a conventional cash register system, for example.

As well as simply checking whether the coupon was redeemed in the past, validity requirements defined in the coupon data can also be checked. Thus the coupon data can include conditions which depend on information unrelated to items, such as a validity period (promotion period) for the coupon, the number of coupons already redeemed by the customer, the restriction on coupon redemption in relation to a particular dealer or a particular branch (point of sale), the geographical area of operation of the coupon, or a minimum invoiced amount above which the coupon is applicable. In the validation, the actual data can be compared with the corresponding conditions of the coupon data. The information unrelated to items is usually stored in the server's database, or can be established by checking the server's internal clock or by analyzing the identification of the point of sale, as transmitted with the query.

The coupon data can also contain one or more conditions which are dependent on item-related information and form validity characteristics of the coupon. Examples of item-related information are e.g.
Number of items,
Unit price of item,
Total price of item,
Number of items in a class of goods,
Total price of all items in a class of goods.

The actual item data can be compared with the coupon data conditions in order to determine the validity of the coupon. For this, the point-of-sale computer can transfer the actual item data recorded by the cash register system to the central computer along with the coupon query. In the validation, the central computer then compares the actual item data with the coupon data conditions, and forwards the coupon ID to the point-of-sale computer only if the conditions are met.

Alternatively, the item-related information can be checked on the point-of-sale computer. The central server can check the conditions unrelated to items, and then transfer to the point-of-sale computer the coupon IDs which are valid according to this first check. The point-of-sale computer can check the item-related conditions, and select from the transferred coupons only those which also meet these item-related conditions.

The coupons-to-customer assignment can be effected and stored on the central computer. It can thereby be ensured that the latest developments (e.g. redemption of the coupon in another shop, or issue of a new coupon by another shop) are always taken into account. The assignment can therefore not be transferred to the cash register systems outside shop opening hours.

However it is also possible, should it be necessary, to perform the validity check based on the temporarily stored coupon data in the point-of-sale computer. This alternative can be utilized in particular if the data communication to the central server is disrupted, or the central server is overloaded. For this purpose, a file can be transmitted nightly to the cash register system or a local computer networked to this, containing the customer IDs of all customers who have activated couponing at all. Especially in the initial phase, this can entirely eliminate or significantly reduce the communication with the server, if only relatively few customers use the procedure.

Based on the validity check, a provisional credit is then created for the customer. The customer can then be advised on his sales slip at the till, for example, that the validity of the coupons cannot be checked at present because of data traffic problems. He can either be promised a voucher for the amount of the discount from the valid coupons after their validity is checked, or notified of a reimbursement of the discounts to his account or his credit card.

In the process step of transfer of a coupon ID in connection with a specific customer ID from the central server to a point-of-sale computer, this coupon ID can be locked for this customer ID in the database of the central server. This is done within the same program section of the computer program running on the central server, and in particular before a second query of coupon IDs assigned to specific customers can be processed by the central server. A duplicate redemption of a coupon by the same customer is thereby prevented. This is significant in particular if the validity check is performed based on the temporarily stored coupon data in the point-of-sale computer. In this case it is possible for two point-of-sale computers to query the coupons of the same customer, in rapid succession. Since this coupon ID is already locked during the execution of the program function which performs the transfer of a coupon ID to a specific customer ID, this coupon ID will not be transferred a second time for the subsequent query referencing coupons for this customer, even if the two queries follow immediately one after the other.

After the payment process for the relevant customer is completed, the point-of-sale computer can create a list of the coupon IDs allowed for in the payment, and send this to the central server. The coupons assigned to the coupon IDs sent in the list in connection with the customer ID are marked by the central server as redeemed or deleted. All further coupons whose ID the central server has transmitted to the point-of-sale computer were not taken into account in this payment process. The locking of these other coupons is therefore cancelled.

With the return transmission of the coupon IDs to the central server, further data relevant for the redemption of the coupon can also be transmitted, e.g. in the case of a variable coupon (discount depends on the size of the amount on the sales slip) the discount granted, and possibly information about the redemption conditions (“Two for the price of one”, “Buy two, get one free” etc.). This data is needed by the central server for the bookkeeping and the billing to the enterprises which issued the coupon. These are usually manufacturers or dealers; the operator of the couponing system can be a separate service provider.

Those coupons which were transmitted from the central server to the point-of-sale computer, but whose coupon IDs were not transmitted back by the point-of-sale computer to the central server, have not been taken into account in this payment process. Their lock can be removed, so that they are once again available for subsequent purchases by the same customer.

The method according to the invention is also extremely suitable for so-called “checkout couponing”, in which a customer is granted a specific discount after making a purchase. After the payment process is completed, the point-of-sale computer, in particular the cash register system, can create a checkout coupon for the relevant customer and transmit it to the central server. The point-of-sale computer does not have to send the entire coupon data to the central server for this. It is sufficient if the point-of-sale computer transmits just the coupon identifier assigned to the coupon and the customer identifier assigned to the customer. After the central server receives this checkout coupon, this coupon too is available to the customer at any point of sale connected to the central server. In the case of checkout couponing too, the complete coupon information is exchanged between the server and point-of-sale computer with greatly reduced data traffic, as only the IDs are transmitted and then assigned to the complete customer profile and complete coupon data on the central server. The customer can additionally be informed about the new coupon by SMS/MMS/email.

### BRIEF DESCRIPTION OF THE DRAWINGS

Embodiments of the invention will now be described with reference to the attached drawings.

FIG. 1 schematically shows an arrangement for executing the method according to the invention.

FIG. 2 shows the sequence of a payment transaction at a point of sale, incorporating the couponing method according to the invention.

FIG. 3 shows a flowchart of a selective checking process, either on the central server or on the point-of-sale computer.

FIG. 4 shows the structure of a system with proxy servers (this can also involve a cascade of proxy servers), which enables offline couponing even when the Internet connection is interrupted.

### EMBODIMENTS OF THE INVENTION

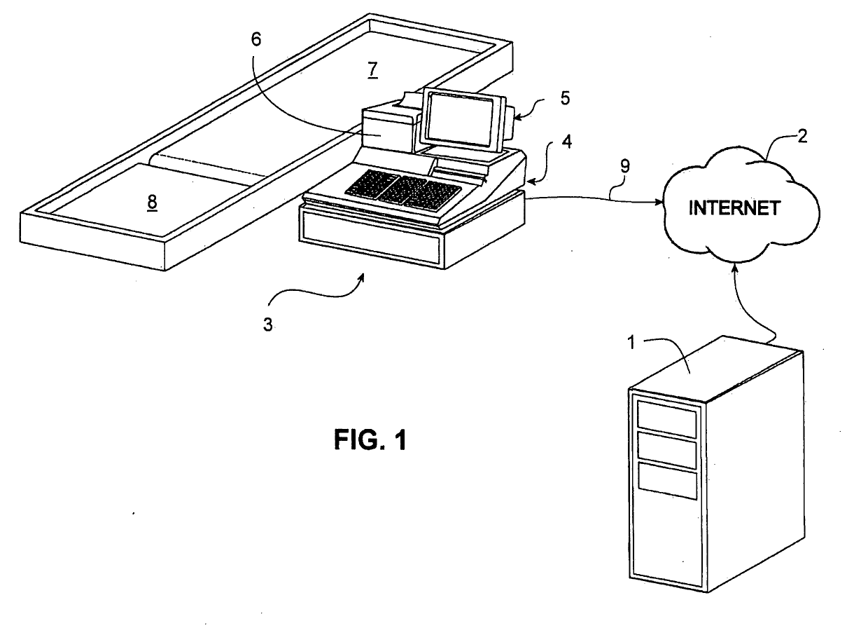

FIG. 1 shows the components of the system on which the method according to the invention is executed. It comprises a central server 1, which has a powerful processor and a large data memory, for example a hard disk with several hundred GB memory space. The server 1 also has a data interface, over which it gains access to the Internet 2. Further components of the central server, such as the connection to the mains and the power supply unit, and the keyboard and screen, are not shown in FIG. 1.

The central server 1 is coupled via the Internet 2 with a cash register system 3. The cash register system comprises an electronic cash register 4 with a display screen 5 and a printer 6 for sales slips and also newly issued coupons. It is coupled in a conventional manner with a conveyor belt 7 and a weighing unit 8 which extends the conveyor belt 7. Products can be weighed for payment on the weighing unit 8. The cash register 4 of the cash register system 3 likewise contains a processor and a local data memory. The cash register system 3 is connected to the Internet, directly or indirectly, via a data line 9. The represented embodiment shows the cash register system 3 of a point of sale with only one till. It forms the point-of-sale computer in this case. Naturally, several cash register systems can access the central server 1 via the Internet. The architecture of the point-of-sale computer can also be more complex, and for example include a central computer to which several cash register systems are connected. The central computer can then serve as a proxy for the cash register systems.

In a payment process, the customer will identify himself/herself to the cash register system. This can be done with a machine-readable customer card or credit card. Alternatively a portable data processing device, like a mobile phone, can communicate with the till to identify the customer uniquely. The cashier can also enter a data record assigned to the customer from the data memory of the cash register system by entering the customer's name. A unique identifier is assigned to the customer. This customer identifier is sent to the central server 1 for the execution of the method according to the invention.

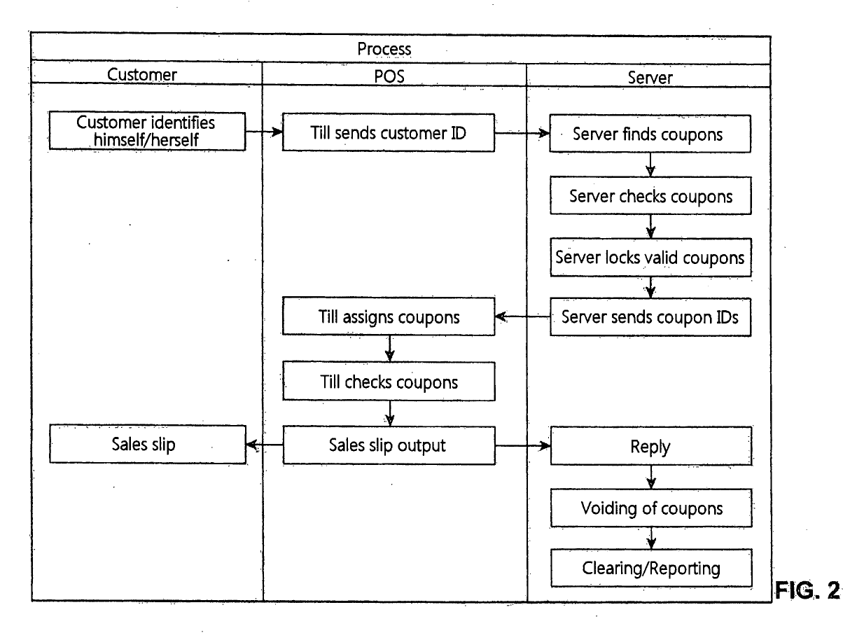

As soon as the central server 1 has received the query from the cash register system 3 with the customer's identification characteristic, the following process takes place (cf. FIG. 2):

1. The server 1 determines all coupons which are in its database and assigned to the customer, and adds them to the answer list.
2. The server 1 checks the found coupons, and removes from the answer list all coupons for which the redemption or issuing conditions are not met.
3. The server 1 locks the valid coupons for further queries in its database.
4. The server 1 sends the cash register system 3 the coupon IDs of all the valid coupons remaining on the answer list.
5. The cash register system 3 can carry out an additional coupon check.
6. At the end of the payment process a sales slip is created, all valid coupons being taken into account and leading to a reduction in the final amount to be paid on the sales slip.
7. A reply is then sent from the cash register system 3 to the central server 1, transmitting the IDs and possibly other data for the coupons which were used.
8. The used coupons are voided.
9. The coupons which are not used but still locked are released, so that they are available for a subsequent purchase transaction.

In the checking of whether or not a coupon can possibly be valid,
(a) item-independent information and
(b) item-related information
   is used.

Information independent of items is for example the current date, current time, the number of coupons already redeemed or issued within a period of time (for example “maximum 1 coupon per day”), the invoiced amount or the ID of the dealer or the ID of the branch.

Item-related information is for example the number of items etc.. This can be sent as additional information to the central server 1 along with the query from the cash register system 3. Each point-of-sale computer or cash register system 3 can be assigned a separate identifier here. However, existing identifiers can also be used. The dealer and/or branch can be identified by the assigned IP address, for example; however, the ID of the dealer or branch is usually included in the transmission.

Further checking criteria for item-independent checks can be the following:
1. Does the coupon's promotion period match today's date?
2. Does the coupon's promotion period match the current day of the week?
3. Does the coupon's promotion period match the current time of day?
4. Has the customer already redeemed a certain number of coupons and therefore reached a personal limit?
5. Can the coupon be redeemed at all with this dealer (using dealer/store ID)?
6. Is the dealer's location within the area of operation?
7. Is the coupon valid at all in terms of the invoiced amount?

These criteria are checked by the central server 1 in order to reduce the quantity of data to be transferred.

Examples of item-related checking criteria could be e.g.:
1. Number of items
2. Individual price of the items
3. Total price for an item (number times individual price)
4. Class of goods of the item
5. Is a certain combination of items present?
6. Is a certain combination of goods classes present?
7. Total price of items in a class of goods

The entire coupon checking can be performed on the central server 1, if this speeds up the payment process. This always makes sense if the cash register systems 3 which are used are obsolete or technically not sufficiently powerful. Cash register systems 3 are generally computer systems which comply with a high security standard. They are designed primarily for reliability. Consequently, the hardware and software components in use are often tried and tested over years, and are generally significantly slower than the most powerful but also most sensitive components. Cash register systems 3 are likewise used over a relatively long period of time, and therefore have an average age exceeding that of computers in computer centers. The average computing speed and performance of a cash register system 3 is therefore usually much lower than that of a modern computer which is used as a central server 1. Thus if the average performance of the point-of-sale computer is much inferior to that of the central server 1, the coupon checking should always be carried out by the central server 1.

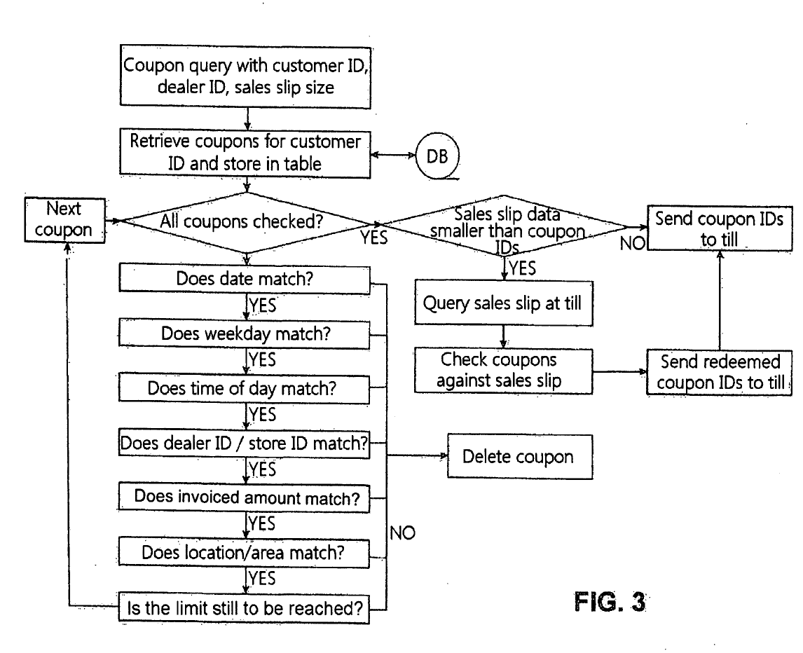

If the computing speed of the point-of-sale computer is equal to that of the central server 1, central coupon checking is always sensible when the quantity of sales slip data (sales data registered by the till for the current purchase transaction) is lower than the quantity of the coupon data already reduced on the IDs. In this case, it can be determined from case to case whether central or local validation is preferable. The following procedure, as illustrated in the flowchart in FIG. 3, would be appropriate for this:
1. Along with the customer ID and the dealer/store ID, the till also sends to the server 1 a numeric value representing the data volume of the sales slip data.
2. The server determines the coupons assigned to the customer ID, and checks the validity of the customer's coupons in accordance with the described item-independent conditions.
3. The server 1 compares the data volume to be sent for the valid coupon IDs with the data volume of the sales slip data.
4. If the data volume of the sales slip data is less, a special code (e.g. “GET SALES SLIP”) is sent as a reply, and the cash register system sends the sales slip data. The validation of the coupons based on item-related criteria then takes place on the central server 1.
5. If the data volume of the sales slip data is greater than the data volume of the assembled coupon IDs, the coupon IDs are sent to the cash register system 3, which locally performs the validation of the coupons based on item-related criteria.
6. The comparison as in step 3 does not have to be purely a smaller/larger comparison. A certain threshold value can be considered, especially if the average cash register system is slower than the central server 1. For example, it can be specified as a condition for the transfer of the sales slip data that their volume is at least “20% less” than that of the coupon data. Furthermore, different data transfer rates for upload and download can also be taken into account in the comparison, as can the latency.

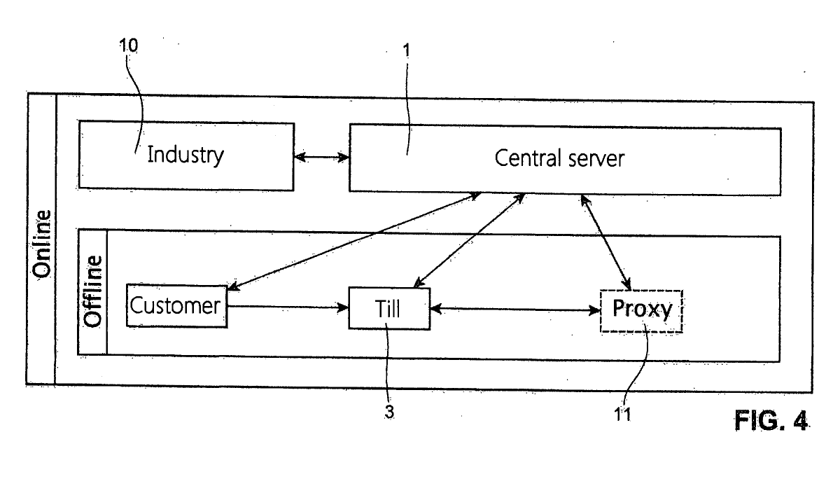

It is additionally feasible that instead of a pure client/server communication, the tasks of the server 1 are also performed by proxy systems, which are arranged in a point of sale (e.g. store), in the dealer's headquarters, or each in one country or state. The data on the proxy systems is also compared in turn with the data on the central server (load distribution, caching). Such a structure can be recognized in FIG. 4.

The central server 1 is operated by the couponing service provider and can be coupled via the Internet with computers 10 of the industry. The computers 10 of the industry (manufacturers, wholesalers etc.) transfer the data of their coupon promotions to the central server 1. In this embodiment, the server 1 communicates not only with the cash register system 3 but also with a proxy 11, which drives several cash register systems 3 in a point of sale (e.g. a store).

The checking can be done in independent software as well as by means of a corresponding database query (SQL statement). Combinations of both variants are possible. If the coupons are transferred as so-called mobile coupons to a mobile communication device belonging to the customer, the central server also communicates with this device.

As explained above, it cannot always be ensured that a sufficiently fast online connection is available. The following methods, also called “offline case”, are provided for this case:
1. Local Storage of the Customer Data
The customer's regular branches are identified from purchases. Alternatively the customer can specify these regular branches personally. In these regular branches, the customer's coupons are replicated daily (local storage) and possibly updated during the day with the transmission of changed data (deltas). Replication occurs if and when the store is online again.
2. If the branch is offline, and the coupon data is not in the local memory, it is possible to transfer the coupons via Bluetooth or other so-called ‘near field communication’ (NFC) technology, from the customer's mobile phone to the till. A provisional discount is granted at once, but the subsequent clearing only takes place when the branch is online again and the transaction has been sent to the central server.
3. Alternatively, if there is no online connection, the sales slip could be stored and transferred later to the server. The server then checks the redemption and issuing conditions after a time delay. The discount is then credited at the next purchase. The customer does have to pay the full price, but nonetheless benefits -after a time delay—from his coupons. If the customer pays with a credit card or debit card, the amount of the sales slip can be debited with a reduction for the amount of the coupons if any, after checking of the redemption and issuing conditions, or a credit for the amount of the valid coupons can be applied to the same credit card or debit card. Or, if bank details are known, the credit is transferred.

Alternatively, for communication with the central server, the (chargeable) connection via the card terminal can also be established. A line is established for this via a telephone connection (modem).

In addition to the generally known till in consumer outlets, for example, the virtual till in online shops is also understood in this description as a point-of-sale computer, till or cash register system. In online shops too, the customer usually, logs on with a customer ID, which can be used for the couponing method.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, hardware, a combination of software and hardware and/or other computer-implemented modules or devices having the described features and performing the described functions. Software implementations of the system described herein may include executable code that is stored in a computer readable medium and executed by one or more processors. The computer readable medium may include a computer hard drive, ROM, RAM, flash memory, portable computer storage media such as a CD-ROM, a DVD-ROM, a flash drive and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1-11. (canceled)

12. A method for issuing and redeeming an electronic coupon, comprising:
creating an electronic coupon by a central server, wherein the electronic coupon includes coupon data with information about a discount granted or a credit and one or more conditions;
assigning the coupon to a customer identifier;
transferring a coupon query from a point-of-sale computer over a data network to the central server, wherein the coupon query includes the customer identifier;
transferring the coupon data from the central server via a data network to the point-of-sale computer,
wherein the coupon data is transferred with an assigned coupon identifier before the payment process from the central server to the point-of-sale computer, and stored in a local memory,
wherein, in a payment process, the central server transfers a coupon identifier assigned to the customer identifier, and
wherein the point-of-sale computer retrieves the coupon data from the local memory using the coupon identifier.

13. The method according to claim 12, wherein, after the customer identifier is transferred, the central server carries out a validation of the coupon assigned to the customer identifier, and only transfers to the point-of-sale computer the coupon identifier which is assigned to a valid coupon.

14. The method according to claim 13, wherein the point-of-sale computer carries out an additional validation and only takes into account the coupon which is valid according to the additional validation.

15. The method according to claim 13, wherein the one or more conditions included in the coupon data includes one or more conditions which are dependent on information unrelated to items, the information unrelated to items including at least one of:
a promotion period of the coupon;
a number of coupons already redeemed by a customer;
redeemability of the coupon at a particular point of sale;
an area of operation of the coupon; and
a minimum invoiced amount,
wherein the at least one of the information unrelated to items forms validity characteristics of the coupon, and wherein the validation includes comparing the one or more conditions of the coupon data with actual data corresponding to the validity characteristics.

16. The method according to claim 13, wherein the one or more conditions included in coupon data includes one or more conditions which are dependent on item-related information, the item-related information including at least one of:
a number of items;
a unit price of item;
a total price of item;
a number of items in a class of goods; and
a total price of all items in a class of goods,
wherein the at least one item-related information forms validity characteristics of the coupon, and wherein the validation includes comparing the one or more conditions of the coupon data with actual item data corresponding to the validity characteristics.

17. The method according to claim 16, wherein the point-of-sale computer transfers item-related information over the data network to the central server, and wherein the central server compares the actual item data with the conditions of the coupon data in the validation.

18. The method according to claim 16, wherein the point-of-sale computer compares the actual item data with the conditions of the coupon data in the validation.

19. The method according to claim 13, wherein the point-of-sale computer carries out a provisional validation of the coupon assigned to the customer identifier, executes a provisional credit using the customer's valid coupon, and executes the final credit after receiving the coupon identifier of the valid coupon.

20. The method according to claim 12, wherein the central server locks the coupon identifier in connection with the customer identifier if the central server transfers the coupon identifier in connection with the customer identifier to a point-of-sale computer.

21. The method according to claim 12, wherein multiple coupons are issued.

22. The method according to claim 21, wherein after the payment process is completed, the point-of-sale computer creates a list of the coupon identifiers allowed for in the payment and sends the list to the central server, and wherein the central server voids the coupons assigned to the coupon identifiers sent in the list in connection with the customer identifier, and releases other coupons.

23. The method according to claim 12, wherein, after the payment process is completed, the point-of-sale computer creates a coupon for the relevant customer and transmits the coupon for the relevant customer to the central server, the point-of-sale computer sending to the central server the coupon identifier assigned to the coupon for the relevant customer and the customer identifier assigned to the relevant customer.

24. A non-transitory computer readable medium storing software that issues and redeems an electronic coupon, the software comprising:
executable code that creates an electronic coupon by a central server, wherein the electronic coupon includes coupon data with information about a discount granted or a credit and one or more conditions;
executable code that assigns the coupon to a customer identifier;
executable code that transfers a coupon query from a point-of-sale computer over a data network to the central server, wherein the coupon query includes the customer identifier;
executable code that transfers the coupon data from the central server via a data network to the point-of-sale computer,
wherein the coupon data is transferred with an assigned coupon identifier before the payment process from the central server to the point-of-sale computer, and stored in a local memory,
wherein, in a payment process, the central server transfers a coupon identifier assigned to the customer identifier, and
wherein the point-of-sale computer retrieves the coupon data from the local memory using the coupon identifier.

25. The non-transitory computer readable medium according to claim 24, wherein, after the customer identifier is transferred, the central server carries out a validation of the coupon assigned to the customer identifier, and only transfers to the point-of-sale computer the coupon identifier which is assigned to a valid coupon.

26. The non-transitory computer readable medium according to claim 25, wherein the point-of-sale computer carries out an additional validation and only takes into account the coupon which is valid according to the additional validation.

27. The non-transitory computer readable medium according to claim 25, wherein the one or more conditions included in the coupon data includes one or more conditions which are dependent on information unrelated to items, the information unrelated to items including at least one of:
a promotion period of the coupon;
a number of coupons already redeemed by a customer;
redeemability of the coupon at a particular point of sale;
an area of operation of the coupon; and
a minimum invoiced amount,
wherein the at least one of the information unrelated to items forms validity characteristics of the coupon, and wherein the validation includes comparing the one or more conditions of the coupon data with actual data corresponding to the validity characteristics.

28. The non-transitory computer readable medium according to claim 25, wherein the one or more conditions included in coupon data includes one or more conditions which are dependent on item-related information, the item-related information including at least one of:
a number of items;
a unit price of item;
a total price of item;
a number of items in a class of goods; and
a total price of all items in a class of goods,
wherein the at least one item-related information forms validity characteristics of the coupon, and wherein the validation includes comparing the one or more conditions of the coupon data with actual item data corresponding to the validity characteristics.

29. The non-transitory computer readable medium according to claim 28, wherein at least one of the following is further performed: the point-of-sale computer transfers item-related information over the data network to the central server, and wherein the central server compares the actual item data with the conditions of the coupon data in the validation, or the point-of-sale computer compares the actual item data with the conditions of the coupon data in the validation.

30. The non-transitory computer readable medium according to claim 25, wherein the point-of-sale computer carries out a provisional validation of the coupon assigned to the customer identifier, executes a provisional credit using the customer's valid coupon, and executes the final credit after receiving the coupon identifier of the valid coupon.

31. The non-transitory computer readable medium according to claim 24, wherein the central server locks the coupon identifier in connection with the customer identifier if the central server transfers the coupon identifier in connection with the customer identifier to a point-of-sale computer.
